(19) United States
(12) Patent Application Publication
(10) Pub. No.: US 2015/0321143 A1
(43) Pub. Date: Nov. 12, 2015

(54) TREATMENT OF INCINERATOR OFF GAS

(71) Applicant: CERAMATEC, INC., Salt Lake City, UT (US)

(72) Inventors: S. ELANGOVAN, South Jordan, UT (US); Joseph Hartvigsen, Kaysville, UT (US)

(21) Appl. No.: 14/707,645

(22) Filed: May 8, 2015

Related U.S. Application Data
(60) Provisional application No. 61/990,466, filed on May 8, 2014.

(51) Int. Cl. B01D 53/32; B01D 53/46; B01D 53/86

(52) U.S. Cl. CPC B01D 53/32; B01D 53/86; B01D 53/46

(57) ABSTRACT

A system treats off gas from a waste incinerator to decrease potentially negative aspects of the off gas to the environment. The system includes a waste incinerator and a plasma oxidizer. The waste incinerator includes an incineration chamber to contain a waste material during at least a portion of an incineration process of the waste material. The waste incinerator also includes an exhaust outlet to exhaust an off gas from the incineration process of the waste material. The plasma oxidizer is coupled to the waste incinerator to receive and oxidize the off gas from the exhaust outlet of the waste incinerator. The plasma oxidizer includes a non-thermal gliding electric arc oxidation system to generate the plasma.

### CROSS-REFERENCE TO RELATED APPLICATION

This application claims the benefit of U.S. Provisional Patent Application Ser. No. 61/990,466 entitled “TREATMENT OF INCINERATOR OFF GAS,” filed May 8, 2014, which application is incorporated by reference.

### TECHNICAL FIELD

The present disclosure relates in general to the treatment of incinerator off gas. More particularly, the present disclosure provides an apparatus and process for treating incinerator off gas that oxidizes and destroys harmful emissions using a non-thermal gliding arc plasma generator.

### BACKGROUND

The use of a safe, complete, and environmentally benign process is useful in the disposal of medical and other waste materials. At least two million tons of medical waste is produced in the U.S. annually.

Conventional methods of disposal of medical waste rely on incineration technology to burn the waste material. Incineration of medical waste is a common method of disposing of pathogenic and potentially infectious materials generated in hospitals and surgical centers. However, conventional incineration technology faces legal, social, and political obstacles. Due to potentially hazardous emissions from these incinerators, the EPA has established rules to regulate the emissions from hospital/medical/infectious waste incinerators (HMIWI). Controlling emissions from an incinerator is critical in meeting these EPA regulations on air quality and the health of the surrounding populations.

The conventional incineration process produces a large volume of off gas that may be harmful to the environment. Off gas results from the use of excess oxygen supplied to the incinerator in an attempt to fully oxidize the waste material. The excess oxygen contributes to the generation of potentially harmful or toxic compositions such as cadmium (Cd), nitrogen oxides (NOₓ), carbon monoxide (CO), dioxins/furan (total, or 2,3,7,8-tetrachlorodibenzo-p-dioxin toxic equivalency (TEQ)), hydrogen chloride (HCl), lead (Pb), mercury (Hg), sulfur dioxide (SO₂), and so forth.

In the incineration process, elimination of dioxins and furans requires control of incinerator conditions (e.g., high temperature, high residence times, and turbulence). However, such conditions may promote the formation of nitrogen oxides. Alternatively, if such conditions are not properly controlled, dioxins and other harmful compositions may be produced due to poor mixing and short residence time at the operating temperature, as well as prolonged exposure at temperatures that favor the formation of dioxins.

Controlling emissions from an incinerator is necessary to meet EPA regulations on air quality and the health of the surrounding populations. The EPA regulates the emissions from the incinerators to reduce air pollution emitted from HMIWI sources.

It would, therefore, be an advancement in the art to provide an apparatus and method that oxidizes and destroys harmful incinerator emissions or off gas.

### SUMMARY

Embodiments of a system are described. A system treats off gas from a waste incinerator to decrease potentially negative aspects of the off gas to the environment. In one embodiment, the system includes a waste incinerator and a plasma oxidizer. The waste incinerator includes an incineration chamber to contain a waste material during at least a portion of an incineration process of the waste material. The waste incinerator also includes an exhaust outlet to exhaust an off gas from the incineration process of the waste material. The plasma oxidizer is coupled to the waste incinerator to receive and oxidize the off gas from the exhaust outlet of the waste incinerator. Other embodiments of the system are also described.

In one non-limiting embodiment, the plasma oxidizer includes a non-thermal gliding electric arc plasma generator. An off gas supply line is coupled to the waste incinerator exhaust outlet to provide the plasma oxidizer with a source of off gas from the incineration process of the waste material. An oxygen supply line is coupled to the plasma oxidizer to provide a source of oxidizer. A fuel supply line is coupled to the plasma oxidizer to provide a source of fuel. The plasma oxidizer includes a gas outlet to remove treated gas from the plasma oxidizer.

In an embodiment, a monitor is provided to monitor an operating condition of the plasma oxidizer. A controller is coupled to the monitor and each of the supply lines to the plasma oxidizer. The controller is configured to operate the fuel supply line and the oxygen supply line dependent on a state of the monitored operating condition. In one embodiment, the monitor includes a temperature monitor to monitor a temperature of the plasma oxidizer. In another embodiment, the monitor includes a gas composition monitor to monitor a composition of the off gas within the supply line of the plasma oxidizer. In yet another embodiment, the monitor includes a gas composition monitor to monitor a composition of the treated gas within the gas outlet of the plasma oxidizer.

In one embodiment, the waste incinerator is a full oxidation incinerator configured to operate with excess oxygen that is more than a stoichiometric amount for fully oxidizing the waste material within the incineration chamber. In another embodiment, the waste incinerator is a partial oxidation incinerator configured to operate with deficient oxygen that is less than a stoichiometric amount for fully oxidizing the waste material within the incineration chamber.

In an embodiment, a storage chamber is coupled between the exhaust outlet of the waste incinerator and the plasma oxidizer. The storage chamber is configured to temporarily store the off gas from the exhaust outlet of the waste incinerator. A compressor may be coupled between the exhaust outlet of the waste incinerator and the plasma oxidizer. The compressor is configured to receive the off gas from the exhaust outlet of the waste incinerator and to direct the off gas into the storage chamber under pressure.

Embodiments of a method are also described. In one embodiment, the method includes oxidizing an off gas from a waste incinerator. An embodiment of the method includes incinerating a waste material in the waste incinerator to generate off gas containing oxidizable species, directing at least a portion of the off gas to a plasma oxidizer including a non-thermal gliding electric arc oxidation system, introducing a stoichiometric excess volume of oxidizer, relative to the oxidizable species, into the plasma oxidizer, introducing a volume of fuel as needed into the plasma oxidizer to maintain a desired operating temperature, and oxidizing the oxidizable species in the plasma oxidizer to form a treated gas.

In some non-limiting embodiments, a stoichiometric excess amount of oxygen is provided to the waste incinerator to incinerate the waste material in an oxidizing mode of the waste incinerator. In other embodiments, a stoichiometric deficient amount of oxygen to the waste incinerator to incinerate the waste material in a fuel value mode of the waste incinerator.

In some non-limiting embodiments, the generated off gas includes gaseous emissions with a congener composition having a toxic equivalence factor (TEF) of about 0.1 or greater. In other non-limiting embodiments, the generated off gas includes gaseous emissions with a congener composition having a toxic equivalence factor (TEF) of about 0.4 or greater. In yet other non-limiting embodiments, the generated off gas includes gaseous emissions with a congener composition having a toxic equivalence factor (TEF) of about 0.75 or greater. In some embodiments, the generated off gas includes dioxin and furan constituents. In other embodiments, the generated off gas includes nitrogen oxide (NOₓ) constituents.

In non-limiting embodiments, the disclosed method includes monitoring an operating condition of the plasma oxidizer and controlling the volume of oxidizer and/or the volume of fuel introduced to the plasma oxidizer in response to detection of a state of monitored operating condition. Examples of the monitored operating condition include, but are not limited to an operating temperature of the plasma oxidizer, a composition of the off gas from the waste incinerator, and a composition of the treated gas from the plasma oxidizer.

For example, the composition of treated gas from the plasma oxidizer may be monitored to determine the free oxygen content. If little or no oxygen is present, then the volume of oxidizer introduced to the plasma oxidizer may be increased. In contrast, if a large amount of free oxygen is present in the treated gas composition, then the volume of oxidizer introduced to the plasma oxidizer may be decreased. In one non-limiting embodiment, the composition of treated gas from the plasma oxidizer is monitored to determine if the composition of treated gas from the plasma oxidizer contains at least approximately 2% free oxygen content by volume. In one non-limiting embodiment, the composition of treated gas from the plasma oxidizer is monitored to determine if the composition of treated gas from the plasma oxidizer contains approximately between 4.0-15.0% free oxygen content by volume.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of an incinerator treatment system for plasma oxidizing off gas.

FIG. 2 depicts a schematic diagram of another embodiment of the incinerator treatment system of FIG. 1 with additional gas storage functionality.

FIG. 3 depicts a schematic diagram of another embodiment of the incinerator treatment system of FIG. 2 with additional system control functionality.

FIG. 4 depicts one embodiment of a method for treating off gas within the incinerator treatment system of FIG. 1.

FIG. 5 depicts one embodiment of a method for controlling the incinerator treatment system of FIG. 3.

FIGS. 6A-C illustrate schematic diagrams of a gliding electric arc plasma generator.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate treatment of off gases from an incineration process. The off gas is rendered harmless, which allows incinerators to be located in cost-effective places such as near the sources of the medical or other waste materials. Also, treatment of the off gas may enable effective transportation of wastes from hospitals, surgical centers, and other sources of waste materials.

In some embodiments, the off gas from an incinerator (after removing particulates and metal contaminants) can be completely oxidized using a non-thermal plasma reactor. Operation conditions of the plasma reactor may completely oxidize the hazardous organic compounds that may be present in the incineration off gas, while not favoring the formation of nitrogen oxides. Thus, the incinerator operating conditions can be selected to reduce formation of nitrogen oxides and other regulated species where the hazardous organic formed can be destroyed in the plasma reactor. In other words, embodiments of plasma reactors can completely oxidize combustible gas species with no or minimal production of nitrogen oxides to meet local regulations.

In some embodiments, the incinerator can be operated in an oxygen lean condition, and the off gas clean-up can be done in the plasma reactor using oxygen (or air). The incinerator can be operated in oxygen (or air) conditions, and the off gas clean-up in the plasma reactor can be done using combustible gas (e.g., methane). The selection of combined operating conditions can be made depending on the waste and the potential hazardous off gas emission.

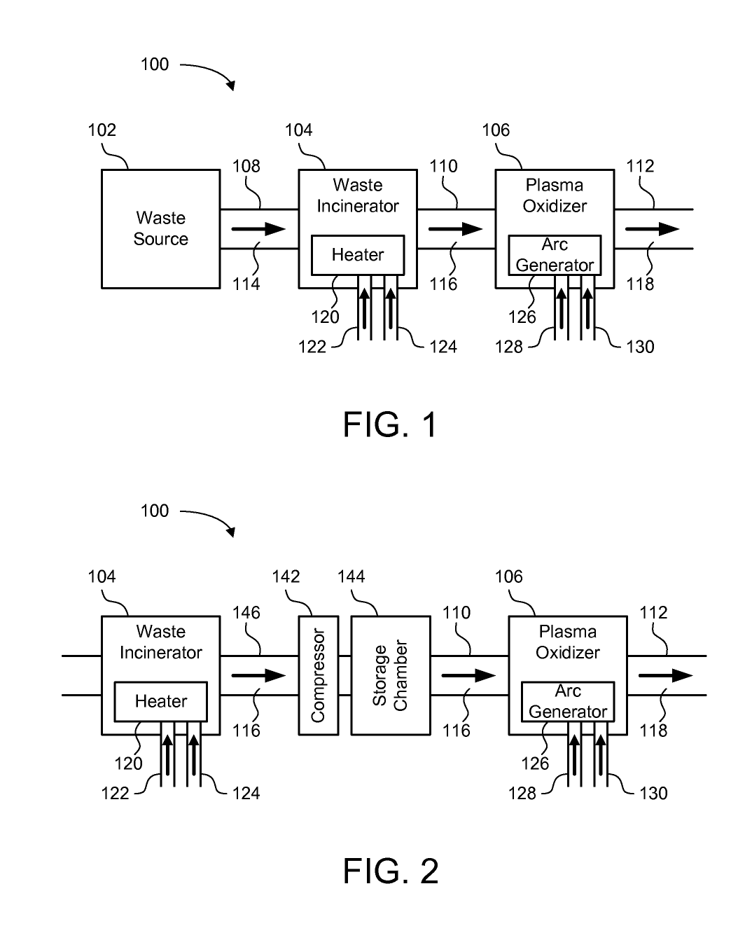

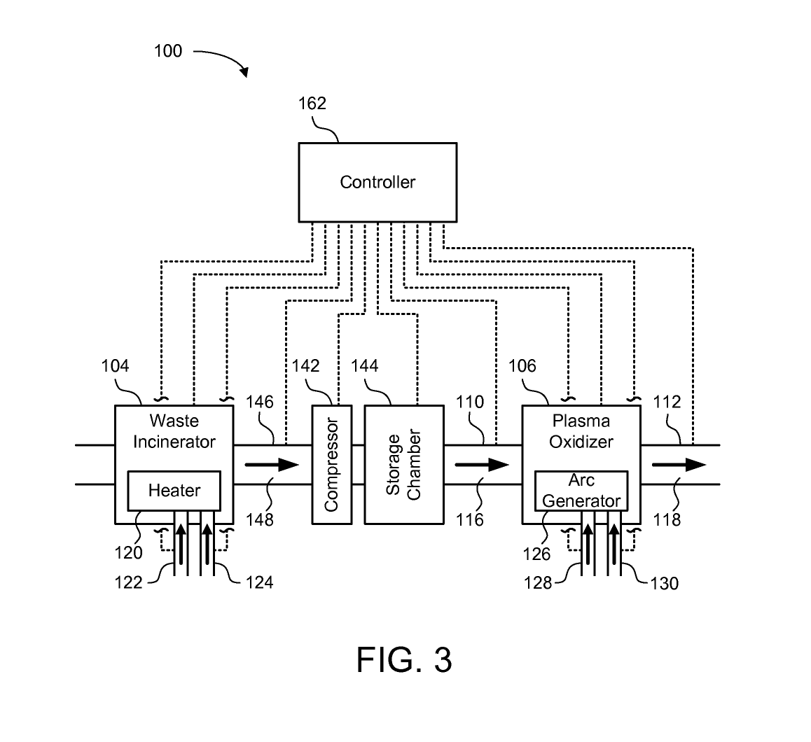

FIG. 1 depicts a schematic diagram of one embodiment of an incinerator treatment system 100 for plasma oxidizing off gas. Although this depicted incinerator treatment system 100 includes specific components and functionality, other embodiments of the incinerator treatment system 100 may include fewer or more components to implement less or more functionality. Some examples of other embodiments of the incinerator treatment system 100 are shown in FIGS. 2 and 3, which are described in more detail herein.

The depicted incinerator treatment system 100 includes a waste source 102, a waste incinerator 104, and a plasma oxidizer 106. The waste source 102 is coupled to the waste incinerator 104 by a waste feed line 108. An exhaust outlet of the waste incinerator 104 is coupled to a supply line 110 for the plasma oxidizer 106. The plasma oxidizer 106 has an exhaust outlet 112.

In general, waste materials 114 from the waste source 102 are introduced into the waste incinerator 104 through the waste feed line 108. The waste incinerator burns some or all of the waste material 114, resulting in off gases 116, ash, slag, or other incineration products. Some or all of the off gases 116 are directed into the plasma oxidizer 106 through the off gas supply line 110. The plasma oxidizer 106 uses an oxidation process to treat some or all of the toxic, noxious, or otherwise undesirable gas constituents of the off gas 116 so that those gas constituents are not emitted into the atmosphere or surrounding environment. This allows the treated gas 118 can be emitted safely into the atmosphere or surrounding environment

The waste source 102 may be any type of chamber, container, or other repository to at least temporarily store, hold, and/or transfer the waste material 114 to the waste feed line 108. There is no limitation on the types of waste materials 114 that may be stored in the waste source 102, as long as the waste source is constructed of materials suitable for the type of waste materials 114 that are stored and the duration of the storage. In some embodiments, the waste material 114 includes medical waste or clinical waste. In other embodiments, the waste material 114 may includes other types of hazardous and/or undesirable waste material.

The waste feed line 108 is also constructed of material that is suitable for the type of waste material 114 that is being stored and transferred for incineration. In other embodiments, the incinerator treatment system 100 may omit a specific channel or physical structure for the waste feed line 108. In such embodiments, the waste material 114 may be dumped directly into the waste incinerator 104. In other embodiments, the waste material 114 may be introduced into the waste incinerator 104 in another manner without the use of the waste feed line 108.

The waste incinerator 104 includes a heater 120 or some other type of heat source to provide the heat used to incinerate the waste material 114. The heater 120 may produce a flame by igniting a fuel that is input to the heater 120 through a fuel supply line 122. There is no limitation on the specific type or arrangement of the waste incinerator 104 that may be implemented within the incinerator treatment system 100. Any waste incinerator 104 that produces off gas 116 can be used. Also, there is no limitation on the specific type of fuel that may be used by the heater 120.

In some embodiments, the waste incinerator 104 can be operated in one of two modes, an oxidizing mode and an oxygen lean mode. In either mode, oxygen or air may be fed into the heater 120 directly, or into another area of the waste incinerator 104, through an oxygen supply line 124. In other embodiments, the waste incinerator 104 can be operated in either the oxidizing mode or the fuel value mode, at different times.

In the oxidizing mode, the amount of oxygen that is introduced into the waste incinerator 104 exceeds the stoichiometric amount necessary for full oxidation of the waste material 114. This does not necessarily mean that all of the waste material 114 is fully oxidized, because some of the waste material may avoid full oxidation due to insufficient mixing, insufficient reaction times, or other typical operating conditions. In fact, some of the oxygen within the waste incinerator 104 may contribute to the formation of NOₓ, dioxins, or other environmentally hazardous gases. By utilizing the incinerator treatment system 100 described herein, these gases can be treated in the plasma oxidizer 106.

In the oxygen lean mode there is a deficiency of oxygen within the waste incinerator 104. In other words, the amount of oxygen available in the waste incinerator 104 is less than the stoichiometric amount (i.e., substoichimetric) necessary for full oxidation of the waste material 114. Although this oxygen-deficient mode may not result in the formation of NOₓ, dioxins, the waste incinerator 104 may emit fuel value gas (e.g., CO, H, tars, oils, etc.) that has a heating value of combustion. By utilizing the incinerator treatment system 100 described herein, the portion of the waste material 114 that was not oxidized in the waste incinerator 104 may be oxidized in the plasma oxidizer 106. Additionally, the fuel value gas may be combusted in the plasma oxidizer 106.

Like the waste feed line 108, the off gas feed line 110 to the plasma oxidizer 106 is constructed of material that is suitable for the composition of off gas 116 that is exhausted from the waste incinerator 104.

In one embodiment, the plasma oxidizer 106 includes a plasma arc generator 126. The plasma arc generator 126 generates an arc of plasma, and the off gas is fed into the plasma arc, along with any accompanying fuel and/or oxygen or air. In some embodiments, the plasma arc generator 126 is a non-thermal plasma arc generator. In other embodiments, there is no limitation on the type of plasma arc generator that may be used to generate the plasma to oxidize the off gas. In further embodiments, there is no limitation on the type of plasma oxidizer that may be used to treat the off gas from the waste incinerator.

In one currently preferred embodiment, the plasma arc generator is a non-thermal gliding electric arc plasma generator such as the kind described in U.S. Pat. No. 8,618,436, U.S. Publication No. 20130277355, U.S. Publication No. 20120118862, and U.S. Publication No. 20090056604, which patents and published applications are hereby incorporated by reference.

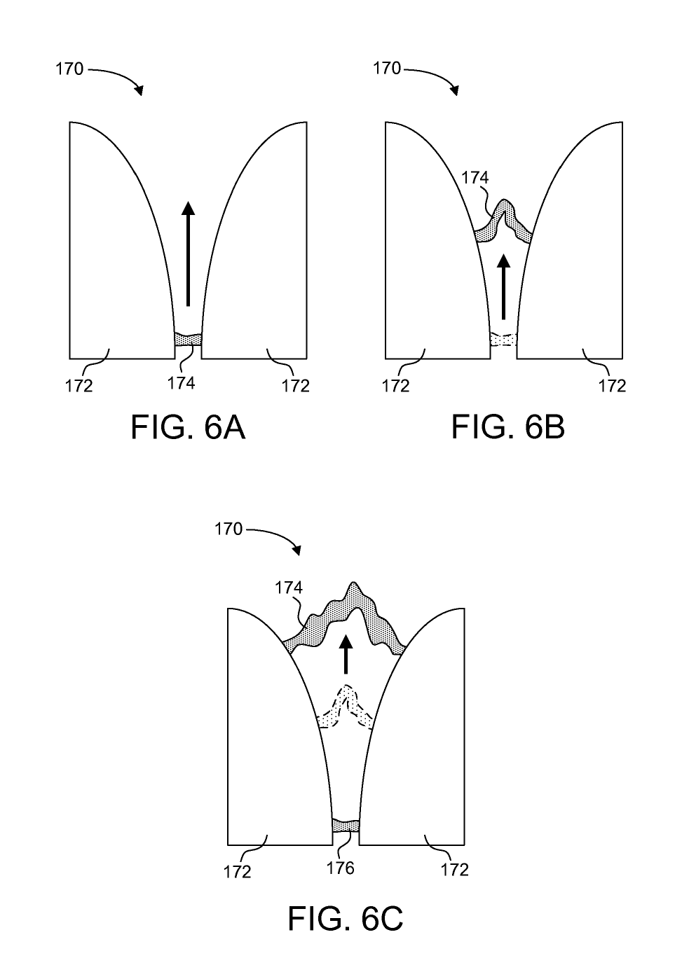

FIGS. 6A-6C illustrate schematic diagrams of a gliding electric arc plasma generator. The depicted plasma generator 170 includes a pair of electrodes 172. However, other embodiments may include more than two electrodes 172. For example, some embodiments of the plasma generator 170 may include three electrodes 172. Other embodiments of the plasma generator 170 may include six electrodes 172 or another number of electrodes 172. Each electrode 172 is coupled to an electrical conductor (not shown) to provide an electrical signal to the corresponding electrode 172. Where multiple electrodes 172 are implemented, some electrodes 172 may be coupled to the same electrical conductor so that they are on the same phase of a single-phase or a multi-phase electrical distribution system.

The electrical signals on the electrodes 172 produce a high electrical field gradient between each pair of electrodes 172. For example, if there is a separation of 2 millimeters between a pair of electrodes 172, the electrical potential between the electrodes 172 is about 6-9 kV.

The mixture of incinerator off gas, oxidizer, and any needed fuel enters and flows axially through the plasma generator 170 (in the direction indicated by the arrow). The high voltage between the electrodes 172 ionizes the mixture of reactants, which allows current to flow between the electrodes 172 in the form of an arc 174, as shown in FIG. 6A. Because the ions of the reactants are in an electric field having a high potential gradient, the ions begin to accelerate toward one of the electrodes 172. This movement of the ions causes collisions which create free radicals. The free radicals initiate a chain reaction for combustion and oxidation of oxidizable species in the off gas.

Due to the flow of the mixture into the plasma generator 170, the ionized particles are forced downstream, as shown in FIG. 6B. Since the ionized particles form the least resistive path for the current to flow, the arc 174 also moves downstream (as indicated by the arrow) and spreads out to follow the contour of the diverging edges of the electrodes 172. Although the edges of the electrodes 172 are shown as elliptical contours, other variations of diverging contours may be implemented. As the arc 174 moves downstream, the effect of the reaction is magnified relative to the size of the arc 174.

Eventually, the gap between the electrodes 172 becomes wide enough that the current ceases to flow between the electrodes 172. However, the ionized particles continue to move downstream under the influence of the mixture. Once the current stops flowing between the electrodes 172, the electrical potential increases on the electrodes 172 until the current arcs again forming a new arc 176, as shown in FIG. 6C, and the plasma generation process continues. Although much of the oxidation process may occur at the plasma generator 170 between the electrodes 172, the oxidation process may continue downstream from the plasma generator 170.

As used herein, the term “non-thermal” plasma is a plasma generated by an electric arc by low electric energy input that is not in thermodynamic equilibrium. The term “non-thermal” does not mean that the plasma is at a low temperature. Instead, the low electric energy input alone is insufficient to maintain the plasma at a high operating temperature.

In some embodiments within the scope of the present invention, the plasma operating temperature is in the range of 900° C. to 1200° C. The existence of oxidizable species in the incinerator off gas, combined with optional additional fuel, and excess oxygen maintain the plasma at a high operating temperature that favors oxidation of species and formation of radicals from nearly all the species present, not just the oxygen. The high temperature and the radicals from most of the species present in the incinerator off gas stream allow for complete oxidation of the oxidizable species.

To maintain a desired plasma operating temperature fuel may be input to the arc generator 126 through a fuel supply line 128 as needed. There is no limitation on the specific type of fuel that may be input to the arc generator 126. In some embodiments a quantity of steam may be added to the fuel supply line to provide temperature control.

To ensure complete oxidation of oxidizable species and fuel, the plasma oxidizer 106 is operated under stoichiometric excess oxygen conditions. Oxygen or air is input to the arc generator 126 through an oxygen supply line 130.

Ultimately, the plasma oxidizer 106 exhausts the treated gas 118. In some embodiments, the treated gas 118 is substantially free of potentially hazardous off gas constituents. Treated gas 118 that is “substantially free” of potentially hazardous off gas constituents includes treated gas 118 that found to pass local regulations or Environmental Protection Agency rules or regulations. In some embodiments, it may be useful to measure the amount of oxygen that is present in the treated gas 118, since the amount of oxygen may be an indicator of the effectiveness of the plasma oxidation process for treating the off gas 116 from the waste incinerator 104. For example, the oxygen content of the treated gas 118 may be monitored to determine if the oxygen content is between about 4.0-15.0%. In another example, the oxygen content of the treated gas 118 may be monitored to determined if the oxygen content is about 2.0% or greater. If the oxygen content is too low, then the volume of oxygen introduced to the plasma oxidizer via the oxygen supply line 130 may be increased. If the oxygen content is too high, then the volume of oxygen introduced to the plasma oxidizer via the oxygen supply line 130 may be decreased.

FIG. 2 depicts a schematic diagram of another embodiment of the incinerator treatment system 100 of FIG. 1 with additional gas storage functionality. In particular, the depicted incinerator treatment system 100 includes a compressor 142 and a storage chamber 144 interposed between the waste incinerator 104 and the plasma oxidizer 106. In the illustrated embodiment, the waste incinerator 104 feeds the off gas 116 to the compressor 142 via an exhaust feed line 146 coupled to an exhaust outlet. The compressor 142 then pressurizes the off gas 116 and stores the pressurized off gas in the storage chamber 144. In other embodiments, the incinerator treatment system 100 may omit compressor functionality, and the off gas 116 may be stored without additional pressurization.

Although the compressor 142 and the storage chamber 144 are shown coupled within the incinerator treatment system 100, in other embodiments, the compressor 142 and/or the storage chamber 144 may be detachable from one or more other components within the incinerator treatment system 100. This detachability may facilitate separate transportation of the stored off gas. In this way, the plasma oxidizer 106 may be located at a different geographic location than the waste incinerator 104, and the stored off gas may be transported from the location of the waste incinerator 104 to the location of the plasma oxidizer 106. The ability to store the off gas for a time decreases the cost of operating the oxidizer. The ability to store the off gas can also facilitate the removal of metals or inorganics that may be solid or may not be oxidizable prior to feeding the plasma oxidizer.

Also, storing the off gas 116 in a separate storage chamber 144 may facilitate handling the off gas 116 in different ways. For example, the temperature of the stored off gas may be controlled separately from the temperature of the waste incinerator 104 and the temperature of the off gas 116 as it is exhausted from the waste incinerator 104. In some embodiments, the temperature of the stored off gas 116 may be lower (e.g., at ambient temperature). In other embodiments, the temperature of the stored off gas 116 may be higher (e.g., heated by a furnace). This temperature independence of the stored off gas may facilitate handling the stored off gas differently or implementing the incinerator treatment process differently.

FIG. 3 depicts a schematic diagram of another embodiment of the incinerator treatment system 100 of FIG. 2 with additional system control functionality. The illustrated incinerator control system 100 includes a controller 162 that may be connected to one or more of the various components within the incinerator treatment system 100. Although several different control paths are shown between the controller 162 and the various components, any combination of control paths to some or all of these components, or other components, may be implemented in different embodiments.

There is no limitation on the types of control information that may be communicated on each of the control paths. In some embodiments, the control paths transmit monitoring information to indicate a state or status of a particular component within the incinerator treatment system 100. In other embodiments, the control paths may transmit identifiers or other metadata. In other embodiments, the control paths may transmit information related to temperatures, gas concentrations, gas compositions, gas measurements, flow rates, and so forth. In further embodiments, the control paths may transmit information or instructions to control valves or other control hardware. Also, there is no limitation on the types of control lines that may be used for control signals. In some embodiments, electronic signaling may be used to communicate between hardware devices. Each hardware device may be implemented solely in hardware or at least partially in software in combination with hardware features.

In some embodiments, the controller 162 is capable of receiving information about the state or status of a component and then sending instructions to control that component or a different component. For example, the controller 162 may receive information about the temperature of the off gas 116 or the plasma zone with in the plasma oxidizer 106 and then send instructions to control the rate that fuel and/or oxygen is fed into the plasma oxidizer 106. In another example, the controller 162 may receive information about one or more constituents of the gas flow entering into or exiting from the plasma oxidizer 106 and then control flow rates and/or oxidizer parameters. There is no limitation on the types of feedback loops that may be established to received information at the controller 162 and correspondingly send out instructions to control one or more components within the incinerator treatment system 100.

Although a single controller 162 is shown for the incineration treatment system 100, other embodiments may utilize more than one controller. The use of multiple controllers may be advantageous in situations where components of the incineration treatment system 100 are located in separate geographic locations such as when a portable storage chamber 144 is used. When multiple controllers are used, the controllers may operate independently of one another or may communication with one another through conventional wired and/or wireless communication protocols.

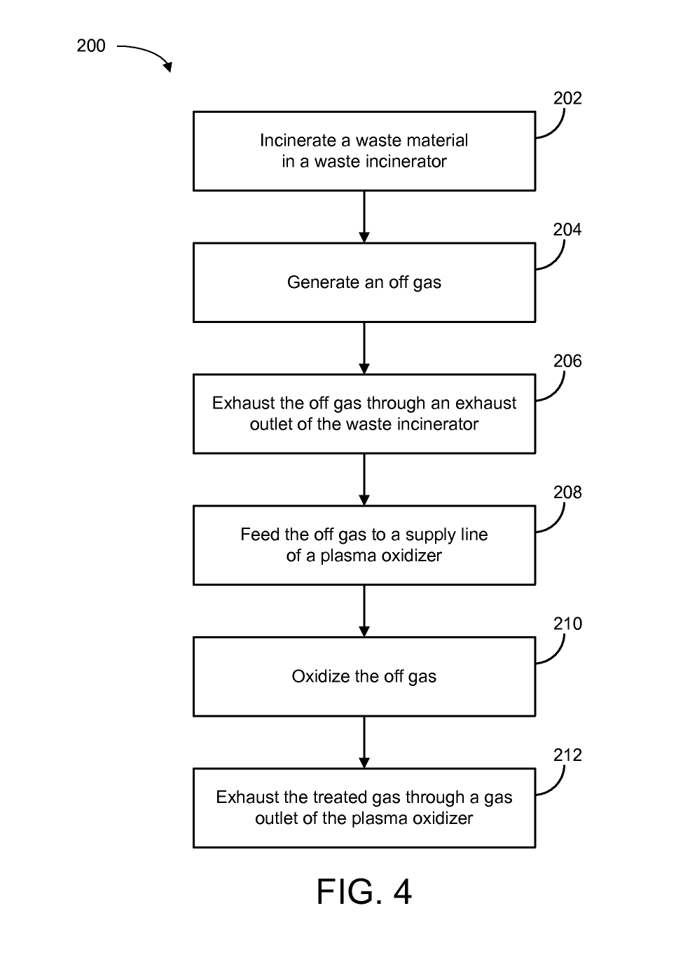

FIG. 4 depicts one embodiment of method 200 for treating off gas within the incinerator treatment system 100 of FIG. 1. Although the method 200 is described in connection with the incinerator treatment system 100 of FIG. 1, embodiments of the method 200 may be implemented with other embodiments of incinerator treatment systems.

The depicted method 200 begins as the waste incinerator incinerates 202 the waste material. As a result of the incineration, the waste incinerator generates 204 the off gas and exhausts 206 the off gas though the exhaust outlet of the waste incinerator.

The exhausted off gas is fed 208 through the supply line to the plasma oxidizer. The plasma oxidizer oxidizes 210 the off gas and exhausts 212 the treated gas out through the gas outlet of the plasma oxidizer. The illustrated method 200 then ends.

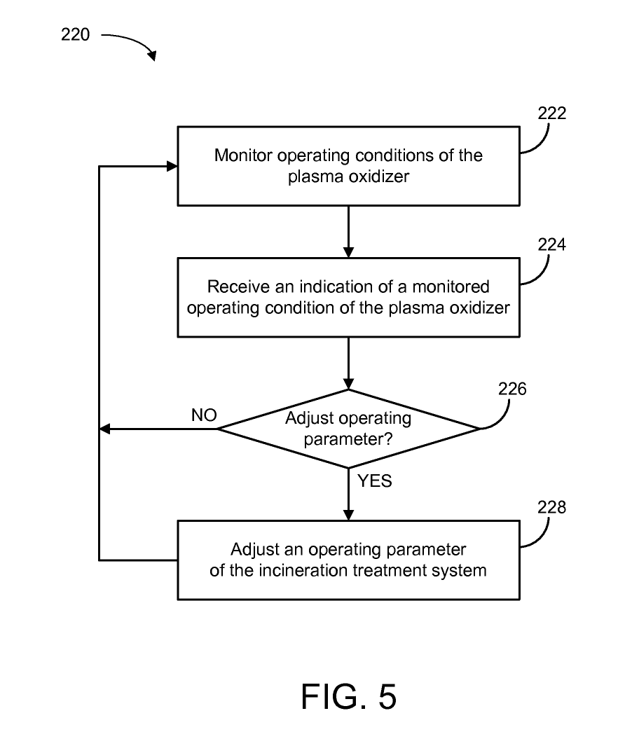

FIG. 5 depicts one embodiment of a method 220 for controlling the incinerator treatment system 100 of FIG. 3. Although the method 220 is described in connection with the incinerator treatment system 100 of FIG. 1, embodiments of the method 220 may be implemented with other embodiments of incinerator treatment systems.

The depicted method 220 begins as the controller monitors 222 one or more operating conditions of the plasma oxidizer. When the controller receives 224 an indication of a monitored operating condition of the plasma oxidizer, the controller uses one or more rules to determine 226 whether to adjust an operating parameter of the incineration treatment system 100.

If the controller determines to adjust an operating parameter, then the controller performs the adjustment 228 and returns to continue monitoring 222 the operating conditions of the plasma oxidizer. Otherwise, if the controller determines that no adjustments are necessary, then the controller returns to continue monitoring 222 the operating conditions of the plasma oxidizer. The illustrated method 220 may continue in the pattern as long as the incineration treatment system 100, or at least the plasma oxidizer, is in operation.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system comprising:
a waste incinerator comprising:
an incineration chamber to contain a waste material during at least a portion of an incineration process of the waste material; and
an exhaust outlet to exhaust an off gas from the incineration process of the waste material, wherein the off gas contains oxidizable species;
a plasma oxidizer comprising:
a non-thermal gliding electric arc plasma generator;
an off gas supply line coupled to the exhaust outlet to provide the plasma oxidizer with a source of off gas from the incineration process of the waste material;
an oxygen supply line coupled to the plasma oxidizer;
a fuel supply line coupled to the plasma oxidizer; and
a gas outlet to remove treated gas from the plasma oxidizer;
a monitor to monitor an operating condition of the plasma oxidizer; and
a controller coupled to the monitor and each of the supply lines, wherein the controller is configured to operate the fuel supply line and the oxygen supply line dependent on a state of the monitored operating condition.

2. The system of claim 1, wherein the monitor comprises a temperature monitor to monitor a temperature of the plasma oxidizer.

3. The system of claim 1, wherein the monitor comprises a gas composition monitor to monitor a composition of the off gas within the supply line of the plasma oxidizer.

4. The system of claim 1, wherein the monitor comprises a gas composition monitor to monitor a composition of the treated gas within the gas outlet of the plasma oxidizer.

5. The system of claim 1, wherein the waste incinerator comprises a full oxidation incinerator configured to operate with excess oxygen that is more than a stoichiometric amount for fully oxidizing the waste material within the incineration chamber.

6. The system of claim 1, wherein the waste incinerator comprises a partial oxidation incinerator configured to operate with deficient oxygen that is less than a stoichiometric amount for fully oxidizing the waste material within the incineration chamber.

7. The system of claim 1, further comprising a storage chamber coupled between the exhaust outlet of the waste incinerator and the plasma oxidizer, wherein the storage chamber is configured to store the off gas from the exhaust outlet of the waste incinerator.

8. The system of claim 7, further comprising a compressor coupled between the exhaust outlet of the waste incinerator and the plasma oxidizer, wherein the compressor is configured to receive the off gas from the exhaust outlet of the waste incinerator and to direct the off gas into the storage chamber under pressure.

9. A method for oxidizing an off gas from a waste incinerator, the method comprising:
incinerating a waste material in the waste incinerator to generate off gas containing oxidizable species;
directing at least a portion of the off gas to a plasma oxidizer comprising a non-thermal gliding electric arc oxidation system;
introducing a volume of oxidizer into the plasma oxidizer, wherein the volume of oxidizer comprises a stoichiometric excess amount of oxygen relative to the oxidizable species;
introducing a volume of fuel as needed into the plasma oxidizer to maintain an operating temperature in the rage of 900° C. to 1200° C.; and
oxidizing the oxidizable species in the plasma oxidizer to form a treated gas.

10. The method of claim 9, further comprising providing a stoichiometric excess amount of oxygen to the waste incinerator to incinerate the waste material in an oxidizing mode of the waste incinerator.

11. The method of claim 10, wherein generating the off gas further comprises generating gaseous emissions with a congener composition having a toxic equivalence factor (TEF) of about 0.1 or greater.

12. The method of claim 10, wherein generating the off gas further comprises generating gaseous emissions with a congener composition having a toxic equivalence factor (TEF) of about 0.4 or greater.

13. The method of claim 10, wherein generating the off gas further comprises generating gaseous emissions with a congener composition having a toxic equivalence factor (TEF) of about 0.75 or greater.

14. The method of claim 10, wherein generating the off gas further comprises generating gaseous emissions with dioxin and furan constituents.

15. The method of claim 10, wherein generating the off gas further comprises generating gaseous emissions with nitrogen oxide (NOₓ) constituents.

16. The method of claim 9, further comprising providing a stoichiometric deficient amount of oxygen to the waste incinerator to incinerate the waste material in a fuel value mode of the waste incinerator.

17. The method of claim 9, further comprising:
monitoring an operating condition of the plasma oxidizer; and
controlling the volume of oxidizer and/or the volume of fuel introduced to the plasma oxidizer in response to detection of a state of monitored operating condition.

18. The method of claim 17, wherein:
monitoring the operating condition of the plasma oxidizer further comprises monitoring an operating temperature of the plasma oxidizer.

19. The method of claim 17, wherein:
monitoring the operating condition of the plasma oxidizer further comprises monitoring a composition of the off gas from the waste incinerator.

20. The method of claim 17, wherein:
monitoring the operating condition of the plasma oxidizer further comprises monitoring a composition of the treated gas from the plasma oxidizer.

21. The method of claim 20, wherein:
monitoring a composition of treated gas from the plasma oxidizer further comprises determining if the composition of treated gas from the plasma oxidizer contains at least approximately 2.0% free oxygen content by volume.

22. The method of claim 20, wherein:
monitoring a composition of treated gas from the plasma oxidizer further comprises determining if the composition of treated gas from the plasma oxidizer contains approximately between 4.0-15.0% free oxygen content by volume.

23. The method of claim 9, further comprising storing the off gas in a storage chamber prior to introducing the off gas into the plasma oxidizer.

24. The method of claim 23, further comprising compressing the off gas and storing the compressed off gas in the storage chamber.
